(19) United States
(12) Patent Application Publication
(10) Pub. No.: US 2026/0247416 A1
(43) Pub. Date: Aug. 20, 2026

(54) CONCURRENT BROADCAST AND UNICAST RECEPTION

(71) Applicant: Parsa Wireless Communications LLC, Stamford, CT (US)

(72) Inventor: Alireza Babaei, Fairfax, VA (US)

(73) Assignee: Parsa Wireless Communications LLC, Stamford, CT (US)

(21) Appl. No.: 18/945,095

(22) PCT Filed: May 4, 2023
(86) PCT No.: PCT/US2023/020929

§ 371 Date: Nov. 12, 2024

Related U.S. Application Data
(60) Provisional application No. 63/340,988, filed on May 12, 2022.

(51) Int. Cl. H04W 72/30; H04L 5/00

(52) U.S. Cl. CPC H04W 72/30; H04L 5/0098

(57) ABSTRACT

A method of concurrent broadcast and unicast data reception includes transmitting, by a user equipment (UE) to a first base station, at least one message comprising one or more information elements (IEs) for use in a concurrent broadcast and unicast data reception and receiving the concurrent broadcast and unicast data in response to transmitting the at least one message and based on the one or more IEs.

### CROSS-REFERENCE TO RELATED APPLICATIONS

This application claims priority under 35 USC § 119(e) from U.S. Provisional Patent Application No. 63/340,988, filed on May 12, 2022 (“the provisional application”); the content of the provisional patent application is incorporated herein by reference.

### BACKGROUND OF THE INVENTION

The present invention is directed to 5G, which is the 5^{th} generation mobile network. It is a new global wireless standard after 1G, 2G, 3G, and 4G networks. 5G enables networks designed to connect machines, objects and devices.

The invention is more specifically directed to systems and/or methods for enhancing user equipment (UE) processes for concurrent unicast and broadcast reception. Example embodiments enhance the UE processes for concurrent unicast and broadcast reception.

### SUMMARY OF THE INVENTION

In an embodiment, the invention provides a method of concurrent broadcast and unicast data reception including transmitting, by a user equipment (UE) to a first base station, at least one message comprising one or more information elements (IEs) for use in a concurrent broadcast and unicast data reception and receiving the concurrent broadcast and unicast data in response to transmitting the at least one message and based on the one or more IEs. The multicast broadcast services (MBS) data may be received by the broadcast data reception. Use of the one or more IEs avoids conflicts between the broadcast reception and unicast reception for the concurrent broadcast and unicast reception. The at least one message may include at least one capability message. The one or more information elements (IEs) may include one or more capability IEs.

In the method, the one or more capability information elements (IEs) may indicate at least one of a number of independent radio frequency (RF) receivers, a number of RF chains, a number of antenna panels, a number of antenna ports, a capability to operate on single frequency band or multiple frequency bands, a first number of supported frequency bands, support for bandwidth part (BWP) switching, support for carrier switching, and multiplexing capability for the concurrent unicast and broadcast reception. The multiplexing capability can be for time division multiplexing of the unicast data and the broadcast data. The multiplexing capability can be for frequency division multiplexing of the unicast data and the broadcast data. The support for carrier switching provides for reception of the unicast data via a first uplink carrier of a cell and for reception of the broadcast data via a second uplink carrier of the cell.

The support for bandwidth part (BWP) switching provides for reception of the unicast data via a first BWP and receiving the broadcast data via a second BWP. The at least one message comprises an assistance message. The assistance message can be a multicast broadcast service (MBS) assistance information message. The at least one message can indicate part of receiver capability that is unavailable for unicast reception. The at least one message can indicate which part of receiver capability is not available for unicast reception. The concurrent broadcast and unicast data reception can be from a single base station. Reception of the broadcast data can be from a first base station and reception of the unicast data is from a second base station. The user equipment (UE) can operate based on a dual connectivity operation. The at least one message can be transmitted to the second base station.

The concurrent reception of the unicast and broadcast data can be via the same bandwidth part (BWP) by the same base station or medium access control (MAC) layer. A single scheduler can avoid scheduling conflict between the unicast and the broadcast data receptions. Avoiding the scheduling conflict may be based on time division multiplexing or frequency division multiplexing. The at least one message can indicates to the first base station a list of multicast broadcast services (MBS) services that the user equipment (UE) is receiving and the time the UE starts or stops receiving them. The concurrent reception of the unicast and broadcast data can be via different bandwidth parts (BWPs). The different bandwidth parts (BWPs) can be of the same carrier by the same base station. The different bandwidth parts (BWPs) can be of different carriers. The at least one message can indicate a capability of the user equipment (UE) to switch between broadcast and unicast bandwidth parts (BWPs) in between broadcast session bursts. The concurrent reception of the unicast and broadcast data can be via different carriers from different base stations or medium access control (MAC) layers within the same operator.

Preferably, the concurrent reception of the unicast and broadcast data is based on at least one second message exchanged between the different base stations. The at least one second message can indicate at least one of first scheduling information of the unicast data and second scheduling information of broadcast data. The concurrent reception of the unicast and broadcast data can be via different carriers from different base stations or medium access control (MAC) layers of different operators. The concurrent reception of the unicast and broadcast data can be based on at least one second message exchanged between the different base stations. The at least one second message can indicate at least one of first scheduling information of the unicast data and second scheduling information of broadcast data.

At least one message can indicate a priority level of each multicast broadcast service (MBS) service identifier with respect to each other or with respect to unicast services. For that matter, at least one message can include one or more of: bandwidth part (BWP) switching information, ability to receive multicast broadcast service (MBS) and unicast data frequency division multiplexed, and one or more MBS service identifiers. The at least one message can also include, for each multicast broadcast service (MBS) identifier, one or more of: a priority level, a user equipment (UE) interest start and end time, frequency resources, time resources, and resources taken by MBS or available for unicast.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows an example signaling according to some aspects of some of various exemplary embodiments of the present disclosure.

FIG. 17 shows an example of unicast and broadcast concurrent delivery scenarios for UEs with single receiver according to some aspects of some of various exemplary embodiments of the present disclosure.

FIG. 18 shows an example process according to some aspects of some of various exemplary embodiments of the present disclosure.

### DETAILED DESCRIPTION

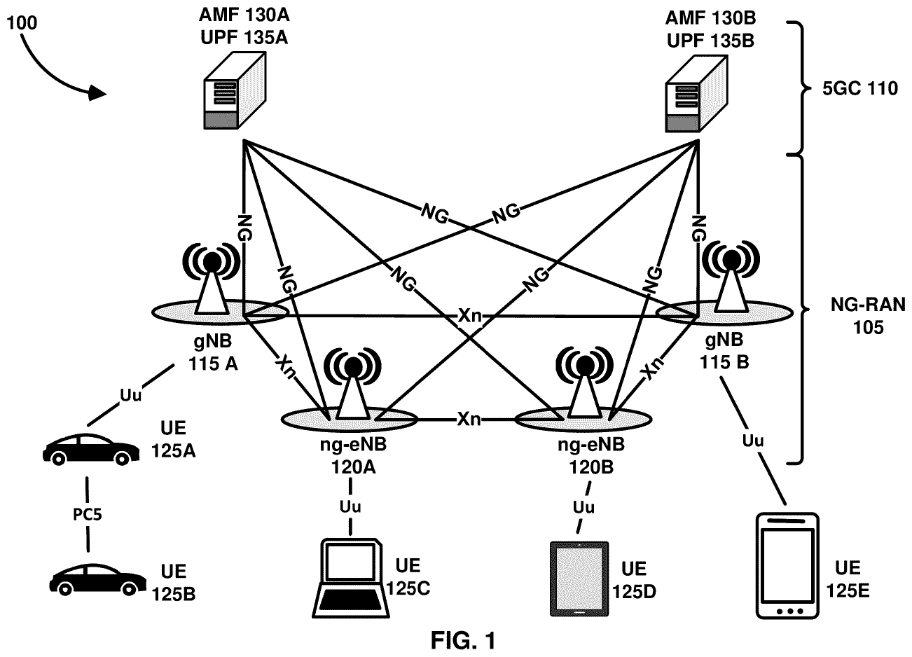

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE 125 B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

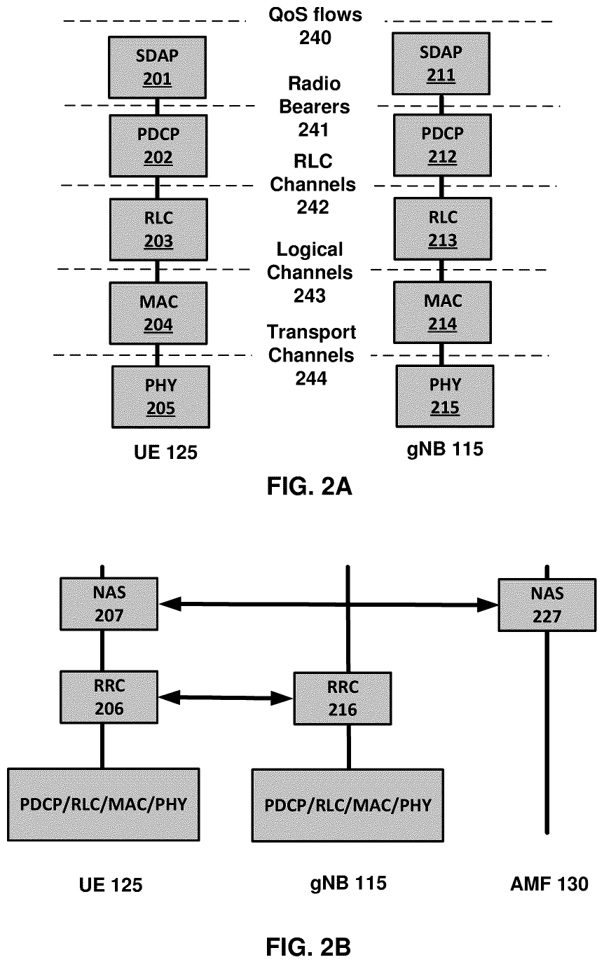

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

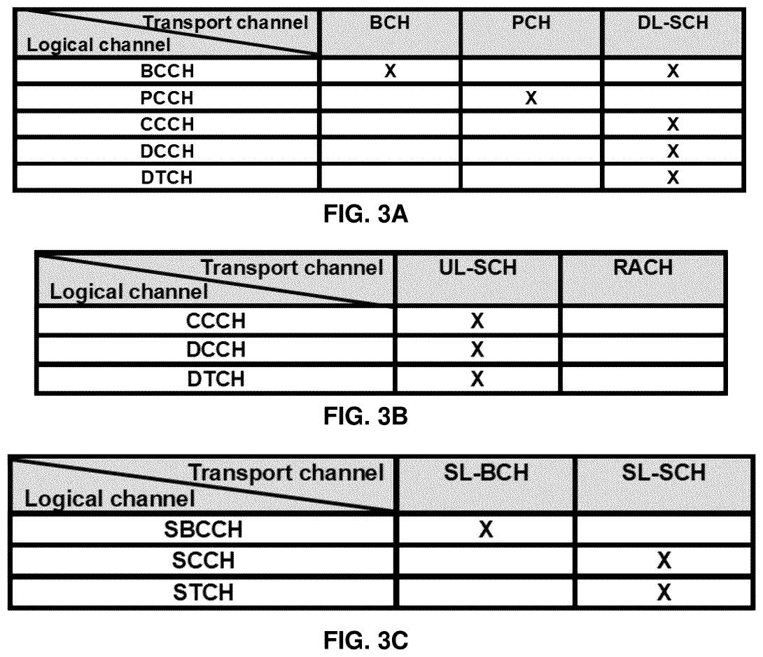

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is a channel for transmitting control information between UEs and the network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving.

The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

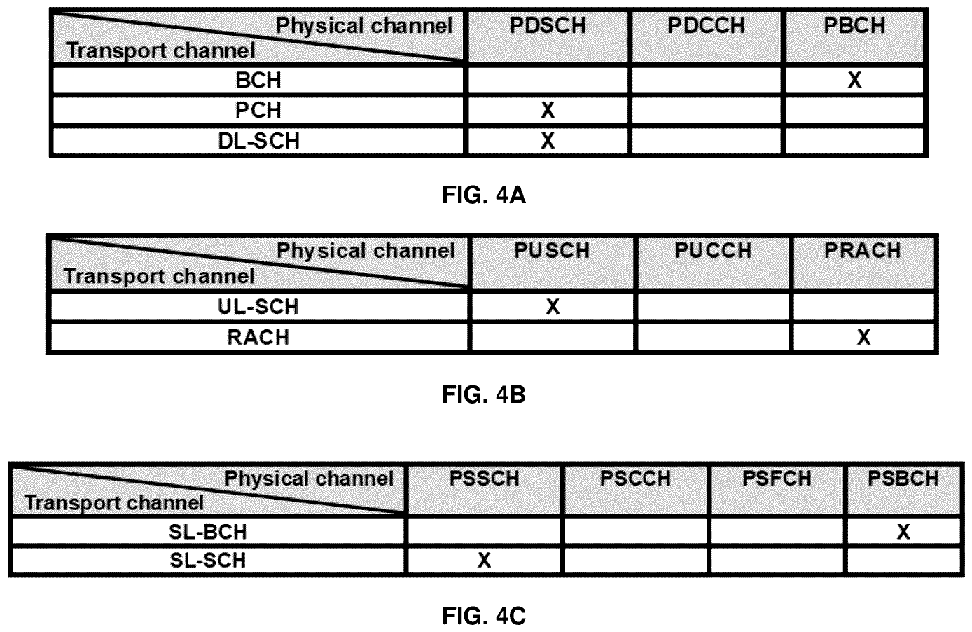

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

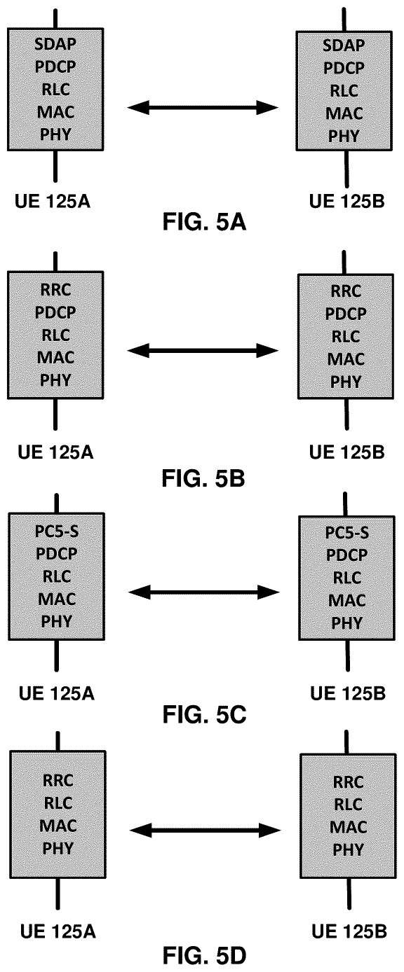

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

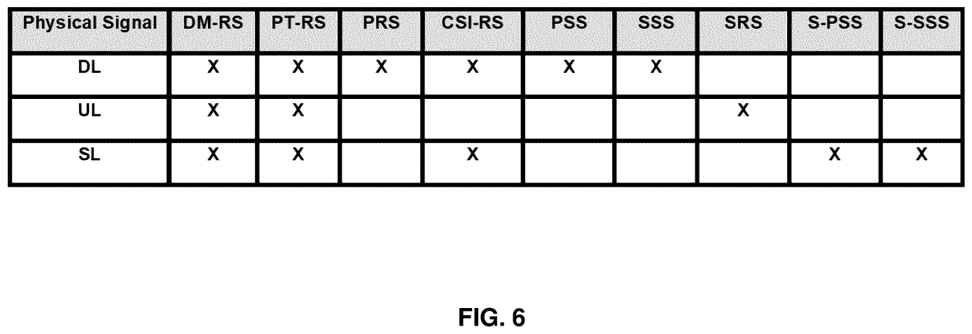

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transmit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

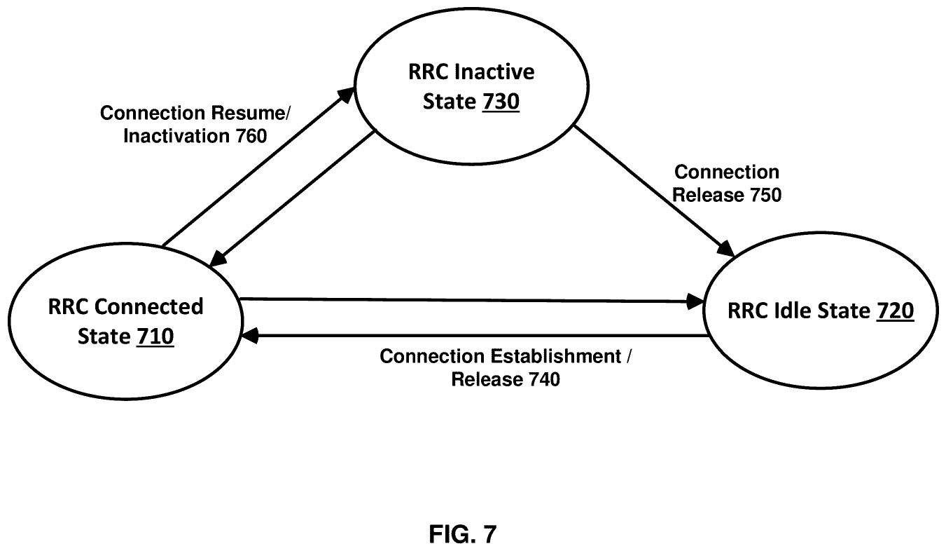

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

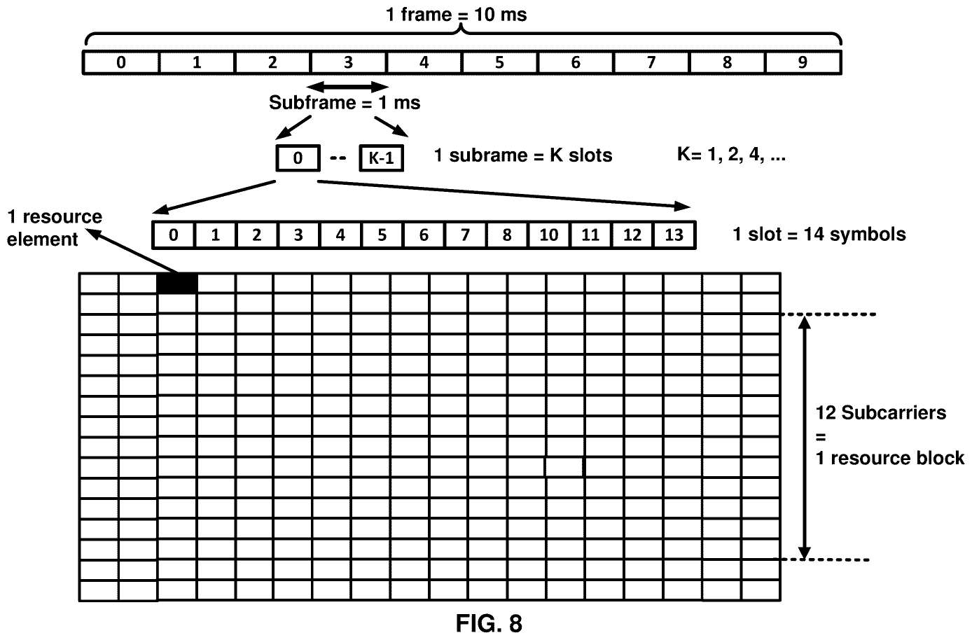

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

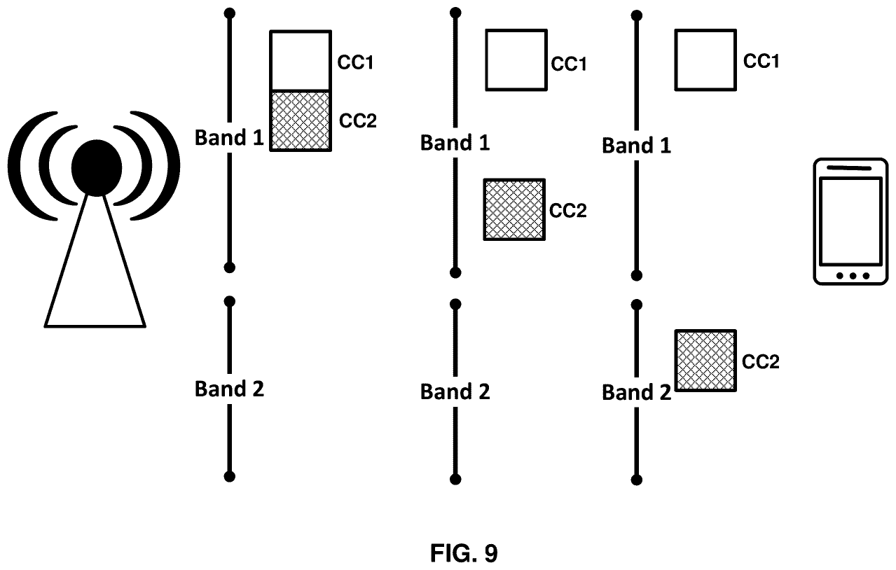

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

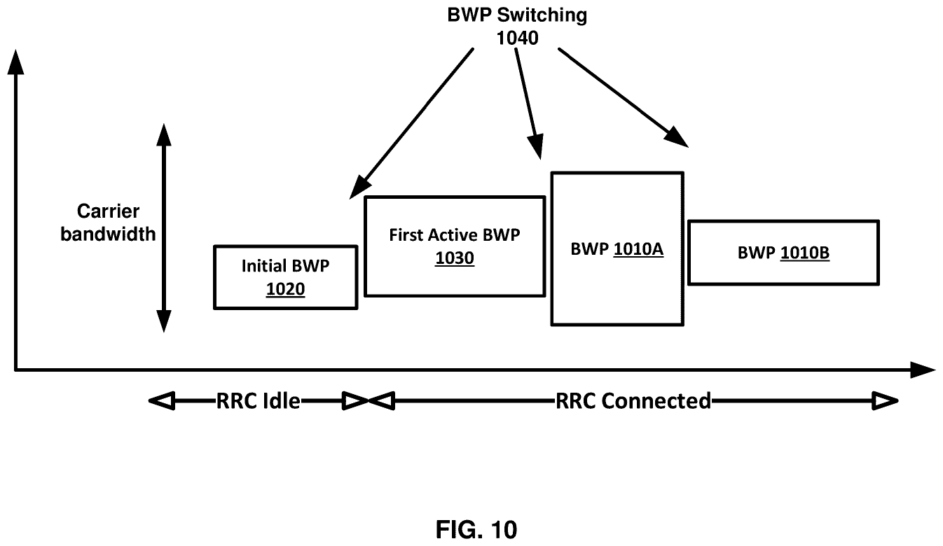

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g., to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

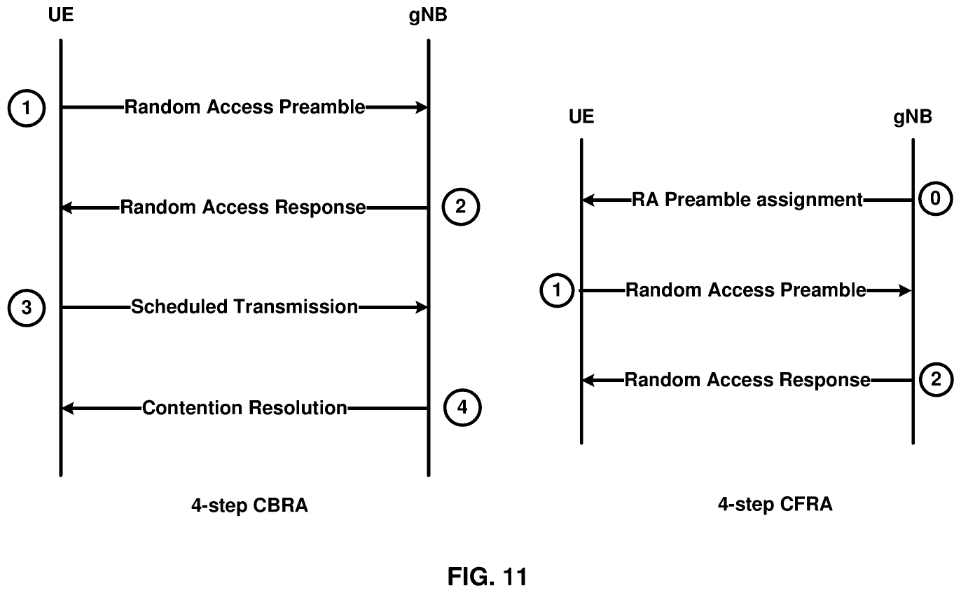

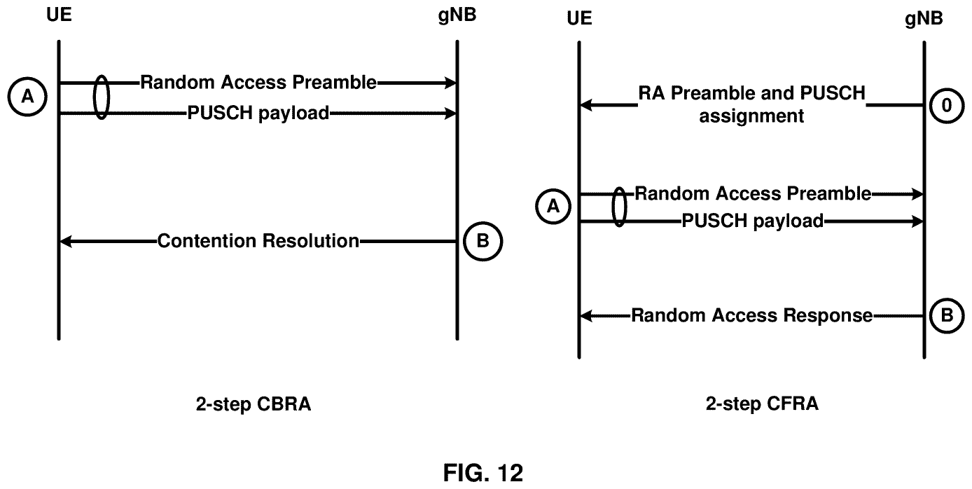

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, an RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

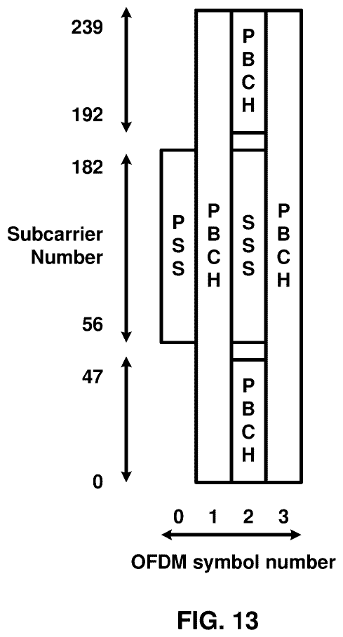

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

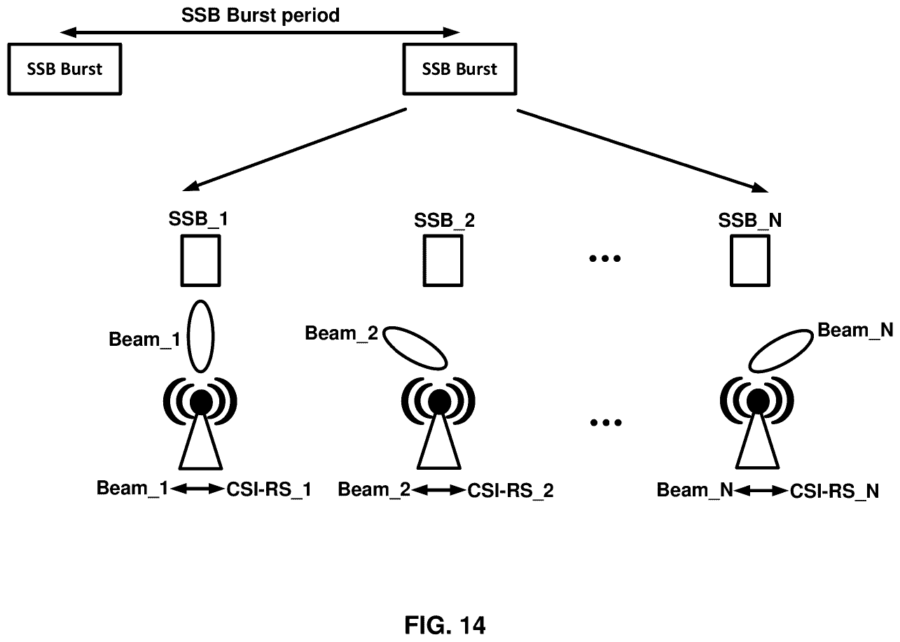

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depend on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

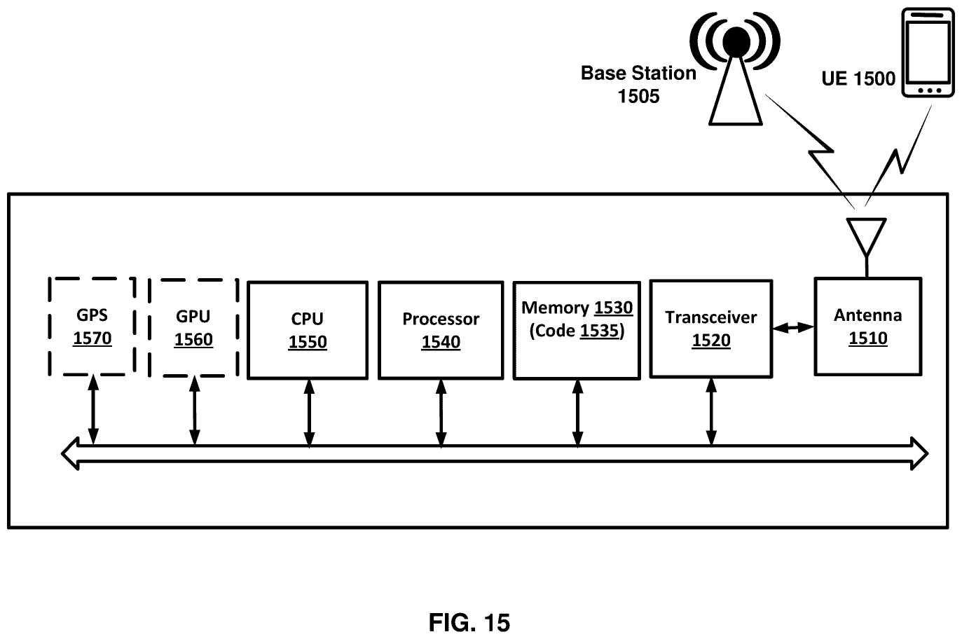

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples and depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In example embodiments, an NR system may enable resource efficient delivery of multicast/broadcast services (MBS).

In some examples, for broadcast communication service, the same service and the same specific content data may be provided simultaneously to UEs in a geographical area (e.g., UEs in the broadcast service area may be authorized to receive the data). A broadcast communication service may be delivered to the UEs using a broadcast session. A UE may receive a broadcast communication service in RRC_IDLE, RRC_INACTIVE and RRC_CONNECTED state.

In some examples, for multicast communication service, the same service and the same specific content data may be provided simultaneously to a dedicated set of UEs (e.g., not all UEs in the multicast service area may be authorized to receive the data). A multicast communication service may be delivered to the UEs using a multicast session. A UE may receive a multicast communication service in RRC_CONNECTED state with mechanisms such as PTP and/or PTM delivery. HARQ feedback/retransmission may be applied to both PTP and PTM transmission.

In some examples, the following QoS model applies to both multicast and broadcast: an MBS Session Resource may be associated with one or more MBS QoS flows; Each MB QoS flow may be associated with a QoS profile.

In some examples, the following logical channels are used for MBS delivery: MTCH: A point-to-multipoint downlink channel for transmitting MBS data of either multicast session or broadcast session from the network to the UE; DTCH: A point-to-point channel for transmitting MBS data of a multicast session from the network to the UE; MCCH: A point-to-multipoint downlink channel used for transmitting MBS broadcast control information associated to one or several MTCH(s) from the network to the UE.

In some examples, the following connections between logical channels and transport channels for group transmission may exist: MCCH may be mapped to DL-SCH; MTCH may be mapped to DL-SCH.

In some examples, the following may depict the usage of RNTI for group transmission: a UE may receive different services using same or different G-RNTIs/G-CS-RNTIs.

In some examples, there may be two delivery modes: 5GC Shared MBS traffic delivery; and 5GC Individual MBS traffic delivery.

In some examples, if the gNB node supports MBS, the network may use the 5GC Shared MBS traffic delivery in which case an MBS Session Resource context for a multicast session may be setup in the gNB when the first UE joins the multicast session.

In some examples, for MBS shared delivery mode, shared NG-U resources may be used to provide MBS user data to the gNB. The gNB node initiates the Multicast Distribution Establishment procedure towards the 5GC, to allocate shared NG-U resources for a multicast session. In case multiple MBS session areas are associated with the MBS session for location dependent MBS services, multiple NG-U shared resources may be established for the same multicast session per MBS Area Session ID served by the gNB.

In some examples, a shared NG-U resource applies one of the following transport options: unicast transport; and multicast transport.

In some examples, for 5GC Shared MBS traffic delivery an MBS Session Resource may comprise one or several MRBs. If minimization of data loss is applied for a given MRB, synchronization of allocation of PDCP SNs may be applied by either or a combination of the following methods: derivation of the PDCP SNs by means of a DL MBS QFI Sequence Number provided on NG-U; deployment of a Shared NG-U Termination at NG-RAN, shared among gNBs, which comprises a common entity for assignment of PDCP SNs.

In some examples, synchronization in terms of MBS QoS flow to MRB mapping among gNBs may be achieved by means of network implementation.

In some examples, if PDCP SNs are derived from a DL MBS QFI Sequence Number provided on NG-U and only one QoS Flow is mapped to an MRB, the gNB may set the PDCP SN of PDCP PDU to the value of the DL MBS QFI Sequence Number provided with the received packet over NG-U. If PDCP SNs are derived from a DL MBS QFI Sequence Number provided on NG-U and multiple QOS Flows are mapped to an MRB, the gNB may derive the PDCP SN of the PDCP PDU from the sum of the DL MBS QFI Sequence Numbers of the QoS Flows mapped to this MRB.

In some examples, a UE may receive data of MBS multicast session in RRC_CONNECTED state. If the UE which joined a multicast session is in RRC_CONNECTED state and when the multicast session starts, the gNB sends RRC Reconfiguration message with relevant MBS configuration for the multicast session to the UE and there is no need for separate session activation notification for this UE.

In some examples, when there is (temporarily) no data to be sent to the UEs for a multicast session, the gNB may move the UE to RRC IDLE/INACTIVE state. gNBs supporting MBS may use a group notification mechanism to notify the UEs in RRC IDLE/INACTIVE state when a multicast session has been activated by the CN or the gNB has multicast session data to deliver. Upon reception of the group notification, the UEs may reconnect to the network. The group notification may be addressed with P-RNTI on PDCCH, and the paging channels may be monitored by the UE. Paging message for group notification may contain MBS session ID which may be utilized to page all UEs in RRC IDLE and RRC INACTIVE states that joined the associated MBS multicast session, e.g., UEs may not be paged individually. The UE may stop monitoring for group notifications related to a specific multicast session once the UE leaves this multicast session.

In some examples, if the UE in RRC IDLE state that joined an MBS multicast session is camping on gNB not supporting MBS, the UE may be notified about multicast session activation or data availability by CN-initiated paging where CN pages each UE individually. If the UE in RRC INACTIVE state that joined MBS multicast session is camping on gNB not supporting MBS, the UE may be notified about data availability by RAN-initiated paging.

In some examples, for multicast service, gNB may deliver Multicast MBS data packets using the following methods: PTP Transmission: gNB may individually deliver separate copies of MBS data packets to each UEs independently, i.e., gNB may use UE-specific PDCCH with CRC scrambled by UE-specific RNTI (e.g., C-RNTI) to schedule UE-specific PDSCH which is scrambled with the same UE-specific RNTI; PTM Transmission: gNB may deliver a single copy of MBS data packets to a set of UEs, e.g., gNB may use group-common PDCCH with CRC scrambled by group-common RNTI to schedule group-common PDSCH which may be scrambled with the same group-common RNTI.

In some examples, if a UE is configured with both PTM and PTP transmissions, a gNB dynamically may decide whether to deliver multicast data by PTM leg and/or PTP leg for a given UE, based on information such as MBS Session QoS requirements, number of joined UEs, UE individual feedback on reception quality, and other criteria. The same QoS requirements may apply regardless of the decision.

In some examples, UE may receive MBS multicast data either from a PCell or a single SCell at a time.

In some examples, the following DRX configuration for PTM/PTP transmission may be possible: for PTM transmission, a multicast DRX pattern may be configured on a per G-RNTI/G-CS-RNTI basis which may be independent of UE-specific DRX for unicast transmission; and for PTP transmission, the UE-specific DRX pattern for unicast may be reused, i.e., the UE specific DRX pattern may be used for both unicast services and the PTP transmission of MBS. For PTP transmission for PTM retransmission, the UE may monitor PDCCH scrambled by C-RNTI/CS-RNTI during unicast DRX's Active time.

In some examples, for delivery of location dependent contents of a broadcast session, Area session ID related information may be included in the NGAP broadcast session resource setup procedure associated with MBS service area information and per Area Session ID NG-U tunnels are established.

In some examples, the UE may receive the MBS configuration for broadcast session (e.g., parameters needed for MTCH reception) via MCCH in RRC_IDLE, RRC_INACTIVE and RRC_CONNECTED state. The parameters needed for the reception of MCCH may be provided via System Information.

In some examples, the following principles may govern the MCCH structure: MCCH may provide the list of broadcast services with ongoing sessions transmitted on MTCH(s) and the associated information for broadcast session including: MBS session ID, associated G-RNTI scheduling information and information about neighboring cells providing certain service on MTCH(s). MCCH content is transmitted within periodically occurring time domain windows, referred to as MCCH transmission window defined by MCCH repetition period, MCCH window duration and radio frame/slot offset; MCCH may use a modification period and MCCH contents may be allowed to be modified at each modification period boundary; A notification mechanism may be used to announce the change of MCCH contents due to broadcast session start, modification or stop and due to neighboring cell information modification; When the UE receives a MCCH change notification, it may acquire the updated MCCH in the same MCCH modification period where the change notification is sent.

In some examples, UE may receive MBS broadcast data and MCCH either from a PCell or a single SCell at a time. Meanwhile, dedicated RRC signaling may be used for providing SIB20 of the SCell i.e., while in RRC_CONNECTED state, UEs may not need acquire broadcast SIB20 directly from the SCells.

In some examples, one PTM DRX configuration may be configured by gNB to a UE for one or multiple G-RNTIs via RRC signaling.

Example embodiments may enhance Uu signaling to allow a UE to use shared processing for MBS broadcast and unicast reception, e.g., including UE capability and related assistance information reporting regarding simultaneous unicast reception in RRC_CONNECTED and MBS broadcast reception from the same or different operators.

Example embodiments may improve the resource efficiency for MBS reception in RAN sharing scenarios.

In some examples, the UE may receive broadcast service in a downlink only manner e.g., performing broadcast reception without a need to access the network beforehand. However, in the typical use case for broadcast, a UE may be required to simultaneously receive broadcast service and unicast service from the network(s) of same or another operator, and some UEs may share the hardware resources between broadcast and unicast. Therefore, the unicast connection might be impacted by the broadcast reception for this kind of UEs. There is a need for optimization for the case of unicast reception in RRC_CONNECTED and broadcast reception from the same or different operators, including emergency and public safety broadcast.

In some examples, a UE capability and related assistance information (e.g., via a new message MBSAssistanceInfo) may be defined regarding simultaneous unicast and broadcast service reception in RRC_CONNECTED from the same or different operators. Without such UE assistance signaling, there may be conflicts between receiving scheduled unicast and broadcast service data for RRC connected UEs. Example embodiments may apply to multi-gNB, multi-operator and multi-RX UE scenarios.

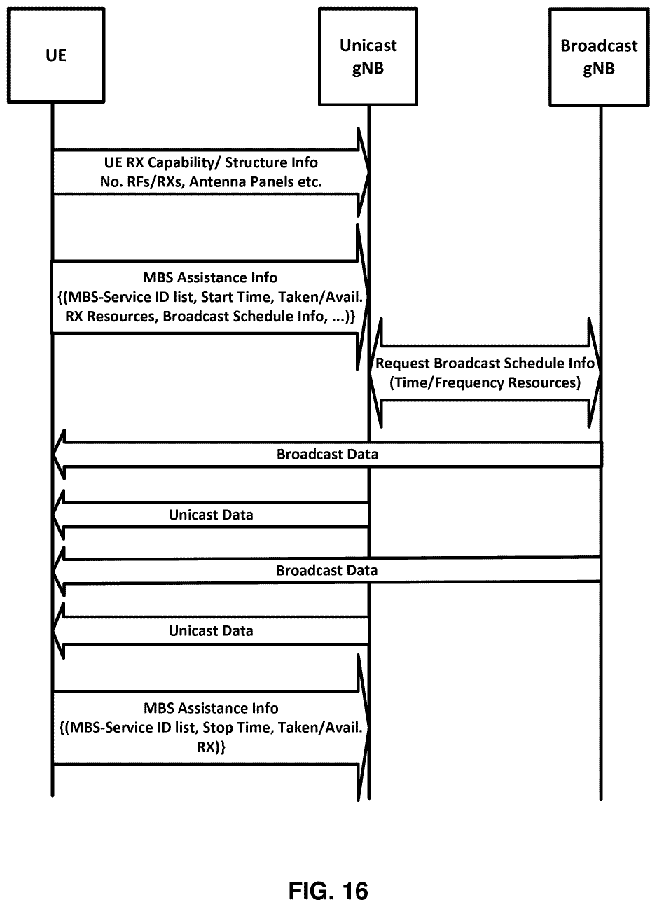

In some examples, UEs may have different receiver capabilities, architectures and limitations involving single or multiple RF parts, antenna ports/panels, etc. More specifically, UEs may be designed with one or multiple RF receivers operating on single or multiple bands and using one or multiple antenna panels which may be used individually or together. UEs may also optionally support BWP of carrier switching while in RRC connected state. Such receiver capabilities and limitations may be considered by unicast gNB to avoid possible conflicts between simultaneous unicast and broadcast reception by the UE. In some examples, e.g., as shown in FIG. 16, for UEs with multiple receivers the UE may provide unicast gNB with its overall receiver's capabilities, e.g., multicarrier or multi-BWP processing. FIG. 16 shows an example of UE RX-Structure-Info and MBSAssistanceInfo Signaling.

In some examples, a UE may indicate its receiver capabilities such as number of independent RF receivers, antenna panels etc. to the gNB as part of capability signaling.

In some examples, the UE receiving or targeting to receive a broadcast service may provide unicast gNB with an adjusted or trimmed set of receiver resources as part of UE's assistance information. In some examples, an MBSAssistanceInfo message/IE may include parts of receiver capabilities/resources that are available or unavailable due to other communications.

In some examples, a UE engaged in receiving MBS services may indicate to unicast scheduling gNB the part of receiver capability that is unavailable for unicast reception. Alternatively, signaling may indicate part of receiver capability that is available for unicast reception.

In some examples, for a UE with a single receiver, the simultaneous reception of unicast and broadcast in RRC Connected state may be achieved by ensuring that unicast and broadcast data are time division multiplexed (TDMed) on different symbols/slots, or alternatively, and if supported by UE, by frequency division multiplexing (FDM) them in the same slot, BWP and Component Carrier (CC). Note that some UEs may not be able to receive two PDSCH at the same time, i.e., slot or mini slot for FDM option may depends on UE capabilities.

In some examples, a UE's concurrent reception of unicast and broadcast data may be achieved by scheduling unicast transmissions for UEs, who may be receiving broadcast data, on a BWP/CCs that includes broadcast BWP/CC at least during broadcast sessions. Taking this approach may require unicast gNB's knowledge of which UEs are receiving or about to receive broadcast data and their BWP/CCs.

In some examples, e.g., when broadcast sessions have long durations, this approach if applied to all UEs and for all broadcast services, may not be scalable as it may cause resource restriction or impact QoS for unicast services. Alternatively, scheduling of unicast on broadcast BWP/CC may be used during broadcast active transmissions and UEs may be required to fall back to UE's unicast BWP/CC in between broadcast data bursts if supported by UE capability. Taking this approach may require the unicast gNB's detailed knowledge of broadcast scheduling times and frequency resources.

In some examples, the MBS Assistance Information may include UE capability to receive frequency divisions multiplexed MBS and unicast data, e.g., in the same (mini)slot.

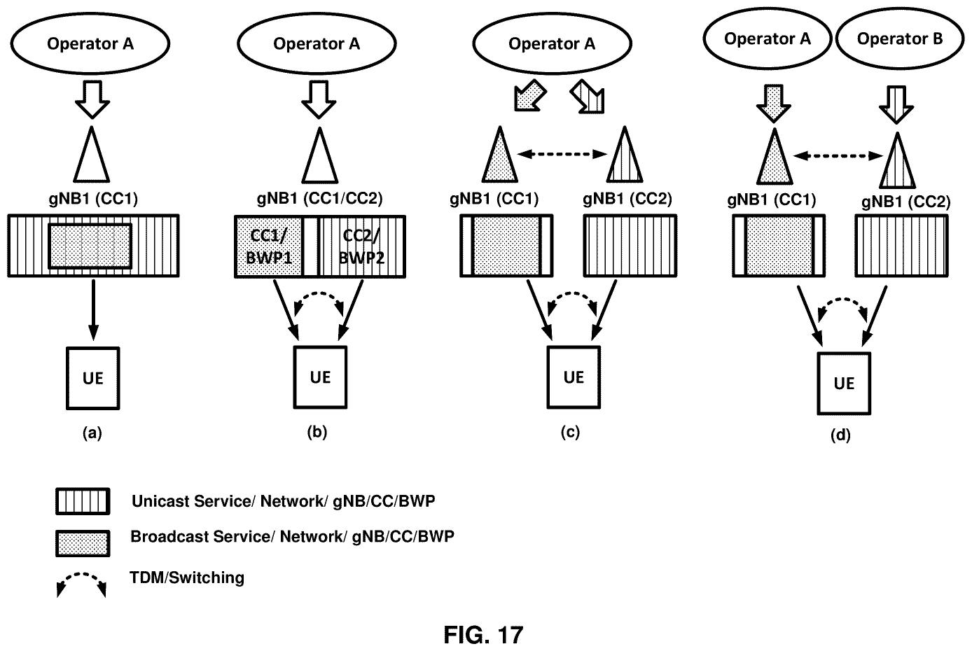

An example of unicast and broadcast concurrent delivery scenarios for UEs with single receiver is shown in FIG. 17.

FIG. 17 shows example concurrent unicast and broadcast delivery scenarios with initial focus on single receiver UE. For UEs with multiple receivers, similar design considerations may apply based on available receiver capabilities that are not engaged in broadcast reception. For example, in scenario a, Unicast and Multicast data may be scheduled and transmitted in the same BWP by the same gNB/MAC. For example, in scenario b, Unicast and Multicast data may be scheduled and transmitted in the different BWP in the same Carrier or on different Carriers by the same gNB/MAC. For example, in scenario c, Unicast and Multicast data may be scheduled and transmitted on different CCs from two gNBs/MAC within a single operator. For example, in scenario d, Unicast and Multicast data may be scheduled and transmitted on different CCs from two gNBs/MAC from two operators.

For Scenario a, there may be no BWP or CC switching and a single scheduler may avoid scheduling conflict between unicast and broadcast data transmissions, e.g., through Time or Frequency division multiplexing. However, without additional information, the gNB may assume that UEs subscribed to broadcast services are actively and always receiving such services and hence gNB may avoid unicast scheduling which may potentially conflict with such broadcast receptions. Such assumption may unnecessarily restrict uncast scheduling and may be avoided by UE's assistance signaling informing gNB about which broadcast services the UE is, or interested in, receiving.

In some examples, the UE as part MBS assistance information may provide the gNB with list of MBS Service IDs that the UE is, or interested in, receiving. For an MBS service, the UE may inform gNB when it starts or stops receiving that service. In some examples, a common scheduler may handle unicast and broadcast service the MAC already has information about CC/BWP and times when an MBS service is scheduled and therefore no more assistance information may be needed.

In some examples, MBS assistance information may provide gNB with list of MBS services UE is receiving, and the time the UE starts or stops receiving them.

Scenario b may be similar to scenario in the sense a single scheduler is handling unicast and broadcast transmission but here given the CC/BWP used for unicast and broadcast may be different depending on BWP/CC switching capability of the UE different approaches may be used. In this case, if BWP/CC switching is not supported, the gNB may schedule unicast data on broadcast BWP/CC during an active broadcast session received by the UE and revert to unicast BWP/CC when UE is not actively receiving the broadcast data. Alternatively, if BWP/CC switching is supported, the gNB may schedule unicasts data in between MBS service data burst and UE may be required to switch to unicast BWP/CC when not actively receiving broadcast data services. In this case the UE assistance to gNB may include list of MBS service IDs, along with timing of when UEs starts and ends its reception of those services, along with UEs BWP/CC switching capability.

In some examples, the MBS Assistance Information may include UE capability to switch between broadcast and unicast BWPs/CCs in between broadcast session burst.

In cases c and d the gNB handling the unicast service, i.e., unicast gNB, may not have information about frequency and time resources, e.g. BWP/CC and schedule, used for such broadcast service transmissions. This information may be provided to unicast gNB through UE assistance directly or in combination with gNB-to-gNB backend communication.

In Scenario c the unicast and broadcast gNBs may be part of the same operator's network and may have coordinated scheduling, e.g., based on dual connectivity framework, through which the unicast gNB may be informed by broadcast gNB about broadcast services scheduled through Xn interface.

In some examples, in scenarios in which unicast and broadcast gNB can coordinate, e.g., through Xn interface, the broadcast scheduling information may be exchanged directly network base stations and may not be included in UE's MBSAssistanceInfo.

In scenario d where communication between two gNBs in two operators next works may not be feasible UE assistance may include all information needed by unicast gNB to avoid scheduling conflicts. Such information includes broadcast service ID as well as time and frequency resources used for its reception, i.e., BWP and scheduling information for broadcast services.

In some examples, in scenarios in which unicast and broadcast gNB cannot coordinate, e.g., they are part or two operator networks, the broadcast scheduling information may be included in UE's MBSAssistanceInfo.

In some examples, the priority of broadcast service compared to unicast service may be considered in case conflict between unicast and broadcast reception cannot be avoided by scheduler.

In some examples, MBSAssistanceInfo may indicate the priority level or each MBS service ID with respect to each other and with respect to unicast services.

In some examples, MBSInterestIndication may be expanded or a new RRC message may be defined as MBSAssistanceInfo to help with unicast and broadcast reception including one or more the following information: BWP Switching, ability to Receive MBS and Unicast FDMed, e.g., in one (mini)slot, MBS Service ID (List), for each MBS-Service-ID: Priority Level, UEs Interest Start/End Time, Frequency Resources MBS-CC/BWP/RBs, Time Resources, Frames/Slots, RX Resources (Taken by MBS or Available for Unicast).

Existing broadcast solution allows that the UE receives broadcast service in a downlink only manner i.e., performing broadcast reception without a need to access the network beforehand. However, in the typical use case for broadcast, the UE may be required to simultaneously receive broadcast service and unicast service from the network(s) of same or another operator, and some UEs may share the hardware resources between broadcast and unicast. Therefore, the unicast connection might be impacted by the broadcast reception for this kind of UEs. There is a need to enhance UE processes for concurrent unicast and broadcast reception. Example embodiments enhance the UE processes for concurrent unicast and broadcast reception.

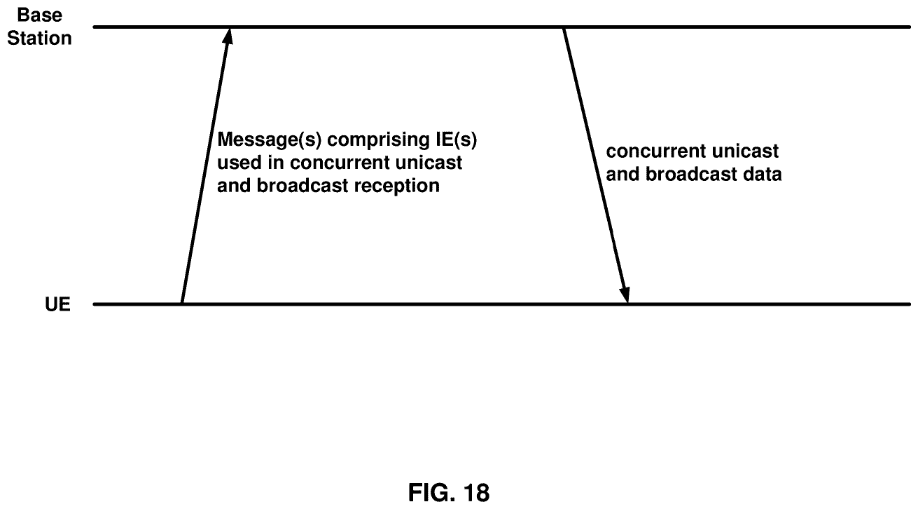

In an example embodiment as shown in FIG. 18, a UE may transmit, to a base station, at least one message, wherein the at least one message is used by the base station to enable concurrent unicast services/data and broadcast services/data (e.g., data associated with one or more MBS services/data) for the UE and/or other UEs. The at least one message may comprise at least one IE that is used by the base station to enable concurrent unicast services/data and broadcast services/data (e.g., data associated with one or more MBS services/data) for the UE and/or other UEs.

In some examples, the at least one message may comprise a capability message and the one or more IEs may comprise one or more capability IEs. For example, the one or more capability IEs may indicate at least one of: a number of independent radio frequency (RF) receivers, number of RF chains, number of antenna panels, number of antenna ports, capability to operate on single frequency band or multiple frequency bands, a first number of supported frequency bands, support for bandwidth part (BWP) switching, support for carrier switching, multiplexing capability for the concurrent unicast and broadcast reception. In some examples, a capability IE may have one of a ‘supported’ or ‘not supported’ values. In some examples, a capability IE may indicate a number (e.g., an integer value). For example, the multiplexing capability may be for/indicate time division multiplexing of the unicast data and the broadcast data. For example, the multiplexing capability may be for/indicate frequency division multiplexing of the unicast data and the broadcast data. For example, the support for carrier switching may be for/indicate reception of the unicast data via a first uplink carrier of a cell and for reception of the broadcast data via a second uplink carrier of the cell. For example, the support for bandwidth part (BWP) switching may be for/indicate reception of the unicast data via a first BWP and receiving the broadcast data via a second BWP.

In some examples, the at least one message may comprise an assistance message (e.g., an MBS assistance information message) and the one or more IEs may comprise one or more assistance IEs that may be used by the base station in processes used by the base station (e.g., for scheduling the UE, e.g., for scheduling for unicast and broadcast services).

In some examples, the one or more IEs may be used to avoid conflicts between the broadcast reception and unicast reception for the concurrent broadcast and unicast reception. For examples, the one or more IEs may be utilized by a base station and based on the values of the one or more IEs, resources may be used for transmission of the unicast data/services and broadcast data/services that avoid conflicts between the unicast and broadcast reception by the UE. The UE may concurrently receive the unicast and broadcast data/services in response to transmitting the at least one message and based on the one or more IEs.

In some examples, the at least one message may indicate part of receiver capability (e.g., hardware capability, e.g., RF chains, antenna panels, resources, etc.) that is unavailable for unicast reception.

In some examples, the at least one message may indicate part of receiver capability (e.g., hardware capability, e.g., RF chains, antenna panels, resources, etc.) that is available for unicast reception.

In some examples, the concurrent broadcast and unicast data reception may be from a single base station. Both of the unicast and broadcast data may be scheduled by and its corresponding data may be transmitted by the same base station.

In some examples, reception of the broadcast and unicast data may be from different base stations, for example, reception of broadcast data may be from a first base station and reception of the unicast data may be from a second base station. For example, the UE may operate according to a dual connectivity operation, wherein the UE is configured with one or more first cells provided by a first base station and one or more second cells provided by a second base station. In some examples, transmitting the at least one message may be to the second base station (e.g., the base station that transmits the unicast data/services).

In some examples, the concurrent reception of the unicast and broadcast data may be via the same BWP of a cell provided by the same base station or medium access control (MAC) layer (e.g., by the same scheduling entity). A single scheduler may avoid scheduling conflict between the unicast and the broadcast data receptions. The scheduler may avoid the scheduling conflict based on a multiplexing technique (e.g., time division multiplexing or frequency division multiplexing). For example, the at least one message may indicate, to the base station, a list of MBS services that the UE is receiving and the time the UE starts or stops receiving them. The scheduling entity may utilize the information provided by the least one message to determine the schedule of the unicast receptions and broadcast receptions (e.g., time frequency resources of the unicast receptions and broadcast receptions, e.g., using FDM or TDM) to avoid the conflict between the unicast and broadcast receptions.

In some examples, the concurrent reception of the unicast and broadcast data maybe via different BWPs (e.g., different BWPs of the same cell/carrier provided by base station or different BWPs of different cells/carriers provided by the same base station or different BWPs of different cells/carriers provided by different base stations, e.g., different base stations of the same operator or different base stations of different operators). In some examples, the at least one message may indicate the UE capability to switch between broadcast and unicast BWPs in between broadcast session burst. The scheduling of the unicast and broadcast, by the one or more base stations, may be based on the UE capability indicated by the UE to one or more of the one or more base stations.

In some examples, the concurrent reception of the unicast and broadcast data may be via different carriers from different base stations or medium access control (MAC) layer within the same operator. In some examples, the concurrent reception of the unicast and broadcast data may be based on at least one second message (e.g., at least one Xn message) exchanged between the different base stations. In some examples, the at least one second message, exchanged between the base stations (e.g., between the unicast base station and the broadcast base station) may indicate at least one of first scheduling information of the unicast data and second scheduling information of broadcast data. The concurrent reception of the unicast and broadcast data may be based on the at least one second message exchanged between the base stations.

In some examples, the at least one message may indicate the priority level of each multicast broadcast service (MBS) service identifier with respect to each other or with respect to unicast services. For example, the at least one message may indicate that the broadcast data has higher priority or lower priority than the unicast data. For example, the at least one message may indicate that first broadcast data associated with a first service or a first service identifier has higher priority than second broadcast data associated with a second service or a second service identifier.

In some examples, the at least one message includes one or more of: bandwidth part (BWP) switching information, ability to receive multicast broadcast service (MBS) and unicast data frequency/time division multiplexed, and one or more MBS service identifiers. In some examples, the at least one message includes, for each multicast broadcast service (MBS) identifier, one or more of: a priority level, a user equipment (UE) interest start and end time, frequency resources, time resources, resources taken by MBS or available for unicast.

In an example embodiment, a user equipment (UE) may transmit, to a first base station, at least one message comprising one or more information elements (IEs) that are used in the concurrent broadcast and unicast data reception. The UE may receive concurrent broadcast and unicast data in response to transmitting the at least one message and based on the one or more IEs.

In some examples, the broadcast data reception may be for reception of multicast broadcast services (MBS) data.

In some examples, one or more IEs may be used to avoid conflicts between the broadcast reception and unicast reception for the concurrent broadcast and unicast reception.

In some examples, at least one message may comprise at least one capability message. In some examples, the one or more information elements (IEs) may comprise one or more capability IEs. In some examples, the one or more capability information elements (IEs) may indicate at least one of a number of independent radio frequency (RF) receivers, number of RF chains, number of antenna panels, number of antenna ports, capability to operate on single frequency band or multiple frequency bands, a first number of supported frequency bands, support for bandwidth part (BWP) switching, support for carrier switching, multiplexing capability for the concurrent unicast and broadcast reception. In some examples, the multiplexing capability may be for time division multiplexing of the unicast data and the broadcast data. In some examples, the multiplexing capability may be for frequency division multiplexing of the unicast data and the broadcast data. In some examples, the support for carrier switching may be for reception of the unicast data via a first uplink carrier of a cell and for reception of the broadcast data via a second uplink carrier of the cell. In some examples, the support for bandwidth part (BWP) switching may be for reception of the unicast data via a first BWP and receiving the broadcast data via a second BWP.

In some examples, at least one message may comprise an assistance message. In some examples, the assistance message may be a multicast broadcast service (MBS) assistance information message.

In some examples, at least one message may indicate part of receiver capability that is unavailable for unicast reception.

In some examples, at least one message may indicate part of receiver capability that is not available for unicast reception.

In some examples, the concurrent broadcast and unicast data reception may be from a single base station.

In some examples, reception of the broadcast data may be from a first base station and reception of the unicast data is from a second base station. In some examples, the user equipment (UE) may operate based on a dual connectivity operation. In some examples, transmitting at least one message may be to the second base station.

In some examples, the concurrent reception of the unicast and broadcast data may be via the same bandwidth part (BWP) by the same base station or medium access control (MAC) layer. In some examples, a single scheduler may avoid scheduling conflict between the unicast and the broadcast data receptions. In some examples, avoiding the scheduling conflict may be based on time division multiplexing or frequency division multiplexing. In some examples, the at least one message may indicate, to the base station, a list of multicast broadcast services (MBS) services that the user equipment (UE) is receiving and the time the UE starts of stops receiving them.

In some examples, the concurrent reception of the unicast and broadcast data may be via different bandwidth parts (BWPs). In some examples, the different bandwidth parts (BWPs) may be of the same carrier by the same base station. In some examples, the different bandwidth parts (BWPs) may be of different carriers. In some examples, at least one message may indicate the user equipment (UE) capability to switch between broadcast and unicast bandwidth parts (BWPs) in between broadcast session burst.

In some examples, the concurrent reception of the unicast and broadcast data may be via different carriers from different base stations or medium access control (MAC) layer within the same operator. In some examples, the concurrent reception of the unicast and broadcast data may be based on at least one second message exchanged between the different base stations. In some examples, the at least one second message may indicate at least one of first scheduling information of the unicast data and second scheduling information of broadcast data.

In some examples, the concurrent reception of the unicast and broadcast data may be via different carriers from different base stations or medium access control (MAC) layer of different operators. In some examples, the concurrent reception of the unicast and broadcast data may be based on at least one second message exchanged between the different base stations. In some examples, the at least one second message may indicate at least one of first scheduling information of the unicast data and second scheduling information of broadcast data.

In some examples, at least one message may indicate the priority level of each multicast broadcast service (MBS) service identifier with respect to each other or with respect to unicast services.

In some examples, the at least one message may include one or more of: bandwidth part (BWP) switching information, ability to receive multicast broadcast service (MBS) and unicast data frequency division multiplexed, and one or more MBS service identifiers.

In some examples, the at least one message may include, for each multicast broadcast service (MBS) identifier, one or more of: a priority level, a user equipment (UE) interest start and end time, frequency resources, time resources, resources taken by MBS or available for unicast.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of’ or “one or more of’. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of concurrent broadcast and unicast data reception, comprising the steps of:
transmitting, by a user equipment (UE) to a first base station, at least one message comprising one or more information elements (IEs) for use in a concurrent broadcast and unicast data reception; and
receiving the concurrent broadcast and unicast data in response to transmitting the at least one message and based on the one or more IEs.

2. (canceled)

3. The method of claim 1, wherein the use of the one or more IEs avoids conflicts between the broadcast reception and unicast reception for the concurrent broadcast and unicast reception.

4. The method of claim 1, wherein the at least one message comprises at least one capability message.

5. (canceled)

6. The method of claim 1, wherein the one or more information elements (IEs) comprise one or more capability IEs and wherein the one or more capability IEs indicate at least one of a number of independent radio frequency (RF) receivers, a number of RF chains, a number of antenna panels, a number of antenna ports, a capability to operate on single frequency band or multiple frequency bands, a first number of supported frequency bands, support for bandwidth part (BWP) switching, support for carrier switching, and multiplexing capability for the concurrent unicast and broadcast reception.

7. The method of claim 6, wherein the multiplexing capability is for one of time division multiplexing of the unicast data and the broadcast data and and for frequency division multiplexing of the unicast data and the broadcast data.

8. (canceled)

9. The method of claim 6, wherein the support for carrier switching provides for reception of the unicast data via a first uplink carrier of a cell and for reception of the broadcast data via a second uplink carrier of the cell.

10. (canceled)

11. The method of claim 1, wherein the at least one message comprises an assistance message.

12. The method of claim 11, wherein the assistance message is a multicast broadcast service (MBS) assistance information message.

13. The method of claim 1, wherein the at least one message indicates part of receiver capability that is unavailable for unicast reception.

14.-16. (canceled)

17. The method of claim 16, wherein the user equipment (UE) operates based on a dual connectivity operation.

18. (canceled)

19. The method of claim 1, wherein the concurrent reception of the unicast and broadcast data is via the same bandwidth part (BWP) by the same base station or medium access control (MAC) layer.

20. The method of claim 19, wherein a single scheduler avoids scheduling conflict between the unicast and the broadcast data receptions.

21. (canceled)

22. The method of claim 1, wherein the at least one message indicates, to the first base station, a list of multicast broadcast services (MBS) services that the user equipment (UE) is receiving and the time the UE starts or stops receiving them.

23. The method of claim 1, wherein the concurrent reception of the unicast and broadcast data is via different bandwidth parts (BWPs), which different bandwidth parts are of the same carrier by the same base station or different carriers.

24.-25. (canceled)

26. The method of claim 23, wherein the at least one message indicates a capability of the user equipment (UE) to switch between broadcast and unicast bandwidth parts (BWPs) in between broadcast session bursts.

27. The method of claim 1, wherein the concurrent reception of the unicast and broadcast data is via different carriers from different base stations or medium access control (MAC) layers within the same operator.

28. The method of claim 27, wherein the concurrent reception of the unicast and broadcast data is based on at least one second message exchanged between the different base stations.

29. The method of claim 28, wherein the at least one second message indicates at least one of first scheduling information of the unicast data and second scheduling information of broadcast data.

30.-33. (canceled)

34. The method of claim 1, wherein the at least one message includes one or more of: bandwidth part (BWP) switching information, ability to receive multicast broadcast service (MBS) and unicast data frequency division multiplexed, and one or more MBS service identifiers.

35. The method of claim 1, wherein the at least one message includes, for each multicast broadcast service (MBS) identifier, one or more of: a priority level, a user equipment (UE) interest start and end time, frequency resources, time resources, and resources taken by MBS or available for unicast.
